(19) United States
(12) Patent Application Publication
(10) Pub. No.: US 2024/0154711 A1
(43) Pub. Date: May 9, 2024

(54) LOCAL MULTI-DEVICE FAST SPATIAL ANCHOR POINT SYNCHRONIZATION METHOD FOR MIXED REALITY AND SYSTEM

(71) Applicant: HOLO INTERACTIVE US, INC., Queens, NY (US)

(72) Inventors: Botao HU, Queens, NY (US); Yuchen Zhang, Queens, NY (US)

(21) Appl. No.: 18/498,637

(22) Filed: Oct. 31, 2023

Related U.S. Application Data
(60) Provisional application No. 63/381,648, filed on Oct. 31, 2022.

(30) Foreign Application Priority Data
Nov. 9, 2022 (CN) 202211397487.2

(51) Int. Cl. H04J 3/06; H04N 13/398

(52) U.S. Cl. CPC H04J 3/06; H04N 13/398

(57) ABSTRACT

A local multi-device fast space anchor point synchronization method for mixed reality includes any device located in the local space serves as a host to create a local network, and other devices join the local network as a guest; the guest and the host first exchange their respective local timestamps, and then calculate the time offset between the guest's local timestamp and the host's local timestamp to achieve time synchronization between the guest and the host; on the basis of time synchronization, the guest in the local network synchronizes the spatial coordinate system with the host through augmented reality picture tracking technology. Other guest can synchronize the spatial coordinate system with the host or synchronized guest to realize the spatial coordinate system synchronization between all devices in the local network. The synchronization method provided by the present application can use multi-person mixed reality applications without an external operator network.

### TECHNICAL FIELD

The application belongs to the technical field of mixed reality, in particular to a local multi-device fast spatial anchor point synchronization method for mixed reality and system.

### BACKGROUND

Mixed Reality (MR), Augmented Reality (AR) is a form of augmented reality that can be achieved by using a HMD (Head Mounted Display) headset, smartphone or other display device. Rendering of virtual content that can be associated with the real world, so that users can see the real world and virtual content superimposed on it and interact with these virtual content technology. Most of the current applications in mixed reality technology are single-player experiences, in which the device renders virtual content that is only visible to the user wearing the device. Even if more than two users are in the same real space, the virtual content is different, so that more than two users can not interact with the same virtual content at the same time. Moreover, since the content rendered by the headset can only be seen by the wearer, the mixed reality experience can only be observed from the first perspective, and the third party without the lead can not see the content that the wearer is playing from the third person perspective, making it difficult to spread the mixed reality experience.

In order to achieve virtual content interaction between different devices, considering that different platforms and devices have different spatial scanning algorithms, if mixed reality devices cannot synchronize space, it is difficult to work together, and the operation of a mixed reality device is difficult to reflect in real time in other mixed reality devices. Therefore, a simple and convenient collaborative work algorithm is needed to synchronize the spatial coordinates between different devices and platforms, which involves the synchronization of the spatial coordinate system of each device.

In order to solve the problem of lack of online interaction between multiple devices, the Chinese invention patent with the authorization announcement number “CN107945116B” discloses the coordinate axis synchronization method for realizing AR indoor positioning between multiple devices. The technical solution includes the following steps: The local coordinate system of each device is established with its own position and gyroscope Angle on each device involved in the connection. Select any device as the primary reference device, other devices as the slave device, the coordinate system of the primary reference device as the primary reference coordinate system, and modify the coordinate system of other slave devices; The slave device obtains the position information of the master reference device and converts it to the slave device coordinates based on the master reference coordinate system. The multi-device coordinate axis synchronization method provided by the technical scheme can form a unified coordinate system among the devices, and carry out more convenient and unified online interaction, which is helpful to realize the combination of virtual and reality in a large range. However, for mixed reality scenarios with high real-time requirements, such as augmented reality multiplayer games, the delay of the Internet Service Provider (ISP) network or the rapid transformation of virtual space will lead to insufficient precision of coordinate synchronization and poor user experience.

In order to improve the accuracy of spatial coordinate system synchronization of mixed reality devices, the Chinese invention patent with the authorization notice number “CN109766001B” discloses a unified method of coordinate system of different MR Devices, which includes: Take any point of the preset space as the reference point, and obtain the relative position and rotation information of each calibration board in the preset space relative to the reference point. Bind each MR Device to the corresponding calibration board; establish a global coordinate system with reference point as the origin; The relative position and rotation information corresponding to the original coordinate system of each MR Device is unified into the global coordinate system. By setting the calibration board and reference point in the preset space, the technical scheme binds the MR Device to the calibration board, determines the position of each MR Device in the global coordinate system established with the reference board as the origin through the relative position and rotation information of the calibration board and reference point, and corresponds the MR Device to the global coordinate system. Different MR Devices can interact in the same scene. The synchronization process of this technical scheme is complicated, resulting in a low synchronization speed of the space coordinate system.

### SUMMARY

Local multi-device fast spatial anchor point synchronization method for mixed reality, including the following steps:
S1: establishing a local network connection for multiple devices located in the local space to achieve data transmission between devices, using any device in the multiple devices as a host to create a local network, other devices as guest to join the local network created by the host.
S2: synchronizing time between the host and the guest in the local network, wherein the guest and the host first exchange their respective local time stamps to each other, and then calculate the time offset between the local time stamp of the guest and the local time stamp of the host, according to the time offset to adjust and realize the time synchronization between the guest and the host.
S3: performing the spatial anchor point synchronization between the host in the local network and the guest, and using a specific picture displayed on the display system of the host as the anchor point. The guest scans the specific picture through the augmented reality picture tracking technology to obtain the second position and rotation of the image anchor point in the space coordinate system of the guest. The first position and rotation of the anchor point in the host space coordinate system under the same time stamp is requested to the host, and the guest obtains two position and rotation data as a pose pair, the guest scans the anchor point several times to obtain multiple pose pairs, and calculates the multiple pose pairs by the least square method. The third position and rotation of the origin of the space coordinate of the host in the space coordinate system of the guest are obtained. By resetting the origin of the space coordinate system of the guest to the third position and rotation, the position and rotation of the origin of the space coordinate system of the host and the space coordinate system of the guest are the same, and the synchronization of the space coordinate system between the devices is completed. Other guests may synchronize spatial coordinate systems with hosts in the local network, or with guests that have completed spatial coordinate systems synchronization in the local network.

Preferably, the step S1 is specifically:
S1-1: The host creates the local network and broadcasts on the local network through wireless communication.
S1-2: The guest searches the broadcast of the host through the wireless communication mode.
S1-3: The guest discovers the broadcast and sends a connection request to the host using the wireless communication mode.
S1-4: The host receives the connection request, agrees to the connection request, and establishes a network connection between the guest and the host.

Preferably, the step S2 is specifically:
S2-1: the guest sends the local time stamp of the guest to the host.
S2-2: the host sends the time point when the local timestamp one is received, to the guest as local timestamp two.
S2-3: the guest receives the time point of the local timestamp two, as the local timestamp three, calculates and saves the timestamp offset between the guest and the host, according to the local timestamp one, local timestamp two and local timestamp three.
S2-4: Repeat steps S2-1 to S2-3 until the number of timestamp offsets reaches the set value to obtain multiple timestamp offsets.
S2-5: Calculate the standard variance of the multiple timestamp offsets, if the standard variance is not less than the preset value, then discard the earliest calculated timestamp offsets and repeat steps S2-1 to S2-3 until the standard variance is less than the preset value, calculate the average of the multiple timestamp offsets as the final timestamp offset result,
S2-6: Other guests calculate the final timestamp offset result between each other guest and the host according to steps S2-1 to S2-5.

Preferably, the formula for calculating the timestamp offset in step S2-3 is:

$$offset = T 1 + \frac{{T0}^{′} - T 0}{2} - T {0}^{′}$$

Wherein T0 is local timestamp one, T0′ is local timestamp two, and T1 is local timestamp three.

Preferably, the guest creates a queue to save the multiple timestamp offsets.

Preferably, the step S3 is specifically:
S3-1: A specific picture is displayed on the display system of the host, and the specific picture is an anchor point in space. The host uses an accelerometer, a gyroscope and an imaging system to calculate the position and rotation of the specific picture in the local coordinate system of the host in real time according to the invariant offset vector of the specific picture and the imaging system of the host.
S3-2: The guest in the local network uses the augmented reality picture tracking technology to scan the specific picture by the imaging system, the augmented reality picture tracking technology identifies the second position and rotation of the specific picture in the scene, sends the second position and rotation to the host, and receives the first position and rotation sent by the host. The first position and rotation and the second position and rotation have the same timestamp
S3-3: The guest obtains the first position and rotation, the second position and rotation under several pairs of different time stamps, and obtains the best displacement vector and the best rotation through least square calculation, and obtains the position and rotation of the local space coordinate system of the host relative to the origin of the local space coordinate system of the guest. The origin of the local space coordinate system of the guest is reset to the origin of the local space coordinate system of the host to complete the synchronization of the space coordinate system of the host and the guest. For other guests in the local network, the space coordinate system of the devices in the local network is synchronized by resetting the origin of its own local space coordinate system to the origin of the local space coordinate system of the host or the origin of the local space coordinate system of any synchronized guests.
S3-4: Render a virtual object with the same size as the host device in the mixed reality virtual space of the guest, and synchronize the position and rotation of the virtual object with the host in real time. If the virtual object does not fully coincide with the host in reality, the guest will repeat steps S3-1 to S3-3, until the virtual object is exactly coincident with the host in reality.

Preferably, the expression for the optimal displacement vector t is:

t=P_{b}− [symbol] _{y}(ϕ)P̅ₐ

Wherein, P^{⊥-}_a represents a weight center value of all anchor points in the host space coordinate system, P^{⊥-}_b represents a weight center value of all anchor points in the guest space coordinate system, and R_y(ϕ) is a rotation matrix with rotating along the space Y-axis.

Preferably, the calculation method for the optimal rotation ϕ is:

$$ϕ = arctan \frac{{\sum }_{i = 1}^{n} {w}_{i} ( - {P}_{a , i , x}^{′} {P}_{b , i , z}^{′} + {P}_{a , i , z}^{′} {P}_{b , i , x}^{′} - {cR}_{i , 3 , x}^{′} + {cR}_{i , 1 , z}^{′} )}{{\sum }_{i = 1}^{n} {w}_{i} ( {P}_{a , i , x}^{′} {P}_{b , i , x}^{′} + {P}_{a , i , z}^{′} {P}_{b , i , z}^{′} - {cR}_{i , 1 , x}^{′} + {cR}_{i , 3 , z}^{′} )}$$

Wherein, P_(a,i,x)\hat{ }′, P_(a,i,z)\hat{ }′ is the difference between an anchor point and its weight center under the host space coordinate system, P_(b,i,x)\hat{ }, P_(b,i,z)\hat{ }′, is the difference between an anchor point and its weight center under the guest space coordinate system, R_(i,1,x)\hat{ }′, R_(i,1,z)\hat{ }′, R_(i,3,x)\hat{ }′, R_(i,3,z)\hat{ }′ is the rotation difference between the host and the space coordinate system of the guest, c is an adjustable constant greater than 0, by adjusting the value of c can make the formula more biased to a smaller rotation error or a smaller displacement error.

A local multi-device fast spatial anchor point synchronization system for mixed reality comprises a memory and a processor, the instructions are stored on the processor, and instructions enable the processor to execute: according to the local multi-device fast spatial anchor point synchronization method for mixed reality described above.

A machine-readable storage medium, wherein instructions are stored on the machine-readable storage medium, and the instructions are used to to cause the machine to execute: according to the local multi-device fast spatial anchor point synchronization method for mixed reality described above.

Compared with the prior art, the present application has the following technical effects:
1. The synchronization method provided by the present application first establishes a local network in the local space, which is helpful to overcome the dependence on the external network and reduce the network delay to improve the precision and speed of spatial synchronization; Then all the devices in the local network are synchronized to further improve the precision of spatial synchronization. On the basis of establishing the local network and time synchronization, by determining the spatial anchor point and calculating the best position and rotation according to the position and rotation of the anchor point in the respective spatial coordinate system, the least square method is used to complete the spatial synchronization between the devices, meeting the real-time and accuracy requirements of the spatial coordinate synchronization in mixed reality applications.
2. The synchronization method provided by the present application selects any device in the local space as the host, establishes the local network through the local wireless communication mode, and other devices join the local network as the guest, overcomes the dependence on the external network environment, and makes multiple devices in the local space in the case of poor or no external network signal. Multiplayer mixed reality apps are also available.
3. The synchronization method provided by the present application utilizes a specific picture displayed by the device display system as an anchor point. The two-dimensional code image is a good choice, because the two-dimensional code image is complex enough and has enough feature points, which is conducive to the quick recognition of the scanning device, and the two-dimensional code image itself has the characteristics of information, which can send additional information from the scanned device to the scanning device without transmission through the network.
4. The synchronization method provided by the present application can be simultaneously applied to the handheld mixed reality device (mobile phone and tablet computer) and the mobile phone-driven mixed reality headset (MID), and any number of the two devices can establish a network and synchronize spatial anchor points through the method, so as to carry out multi-person mixed reality experience.
5. The synchronization method provided by the present application uses the augmented reality picture tracking technology to perform fast spatial coordinate synchronization between two devices by scanning the specific picture displayed on the host screen as an anchor point on the guest, or to perform fast spatial coordinate synchronization between two devices by scanning the specific picture displayed on the synchronized guest screen as an anchor point on the guest. Without the need to manually input information in advance, the spatial coordinate system can be synchronized, and the synchronization speed is fast.
6. The synchronization method provided by the present application supports any number of mixed reality devices to connect and synchronize spatial coordinates in the local space. When the number of devices exceeds two, the subsequent devices can synchronize spatial coordinates by means of chain picture tracking. The chain picture tracking here means that, assuming that host. A and guest B have established A network connection and completed synchronization, the newly added guest C can not only synchronize the space coordinates by scanning the specific picture displayed by host A, but also synchronize the space coordinates by scanning the picture displayed by guest B. Similarly, when guest D is added, guest D can complete the spatial coordinate synchronization with all devices by scanning the specific picture on any device A, B, and C to provide convenient synchronization between spatial coordinate systems.
7. In the stage of spatial synchronization, the synchronization method of the present application uses the least square method to calculate the best rotation and the best displacement values between a pair of spatial coordinate systems, which can easily obtain unknown data and minimize the sum of squares of errors between the obtained data and the actual data, so as to ensure the accuracy of spatial synchronization between different spatial coordinate systems.

### BRIEF DESCRIPTION OF THE DRAWINGS

FIG. 1 is the flow chart of the local multi-device fast spatial anchor point synchronization method for mixed reality according to the present application.

FIG. 2 is the networking flow chart between local devices of the local multi-device fast spatial anchor point synchronization method for mixed reality according to the present application.

FIG. 3 is the time synchronization flow chart between local devices of the local multi-device fast spatial anchor point synchronization method for mixed reality according to the present application.

FIG. 4 is the flow chart of spatial synchronization between local devices for the local multi-device fast spatial anchor point synchronization method for mixed reality according to the present application.

### DETAILED DESCRIPTION OF THE EMBODIMENTS

In order to make the purpose, technical scheme and advantages of the present application more clear, the technical scheme of the present application will be described clearly and completely in combination with specific embodiments of the application and with reference to the attached drawings.

Please refer to FIG. 1 for a flow chart of this embodiment.

The synchronization method in this embodiment includes three steps: (1) Establishing a local network, one device in the local space as a host to create a local network, and other devices as the guest to join the local network; Second, the local time stamp synchronization of multiple devices in the local network, the time synchronization between the host and the guest by calculating the offset of the local time stamp; Third, the local network multi-device fast spatial anchor point synchronization, the host and guest, or guest and guest through the picture tracking technology to share the same picture anchor position information and rotation information, combined with time information to synchronize the space coordinate system.

Spatial Anchor points represent physical points that exist in the virtual world. For mixed reality applications, holograms can be attached to spatial anchor points. A spatial anchor point can be stored and persisted and later queried by the device that created it or any other supported device. This enables anchor backup and anchor sharing. For example, two people on the device can view the board in the same place in the real world (the desktop). No matter where you move in physical space, the board will be fixed to a point.

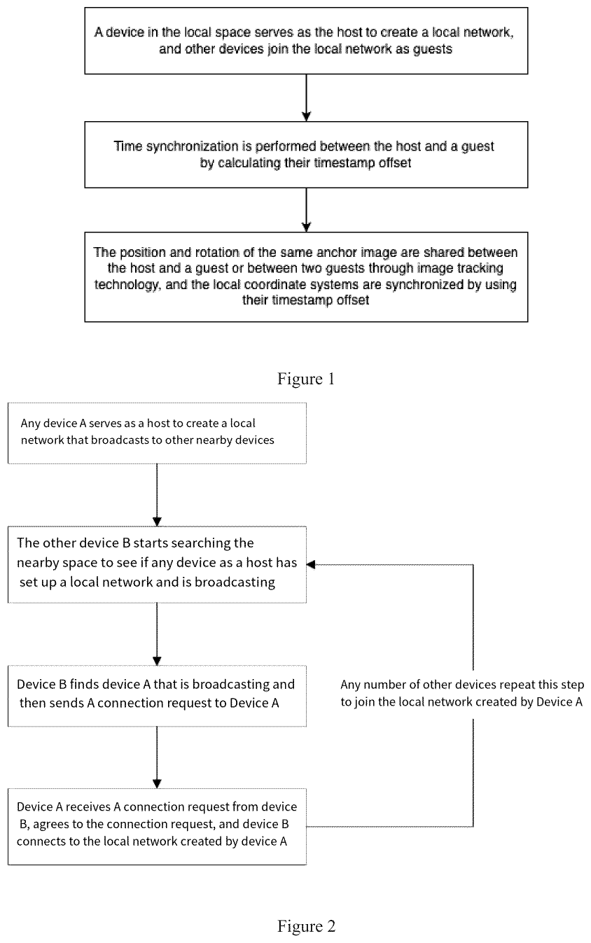

Please refer to FIG. 2 for the networking flowchart between local devices for this embodiment.

If there are more than one (two or more) devices on the host, any device can serve as a host to create a local network, and other devices can serve as the guest to join the local network established by the host. First, any device A in the local space creates a local network as a host and continuously broadcasts its presence to all nearby devices. Then, another device B in the local space starts to try to join the local network, device B starts to search for A host in the nearby space that has established A local network is broadcasting itself, Device B searches for the presence of host A, and sends a connection request to host A. Finally, after receiving the connection request from device B, host A agrees to the connection request, so that device B joins the local network as guest B. Any number of subsequent devices can be added as guest to the local network created by host A by repeating the above process.

The local network in this embodiment is based on Bluetooth or wireless local area network (Wi-Fi) and can be directly point-to-point connected without the mobile provider network (4G or 5G) and the router providing the Internet, avoiding the delayed interference of the Internet. There is no need for the user to do anything when the device is connected, as long as the relevant application software is opened on the phone or tablet, the device will automatically connect to each other. Multiple devices in the local space can also use multi-person mixed reality applications when the external network signal is not good or no external network signal.

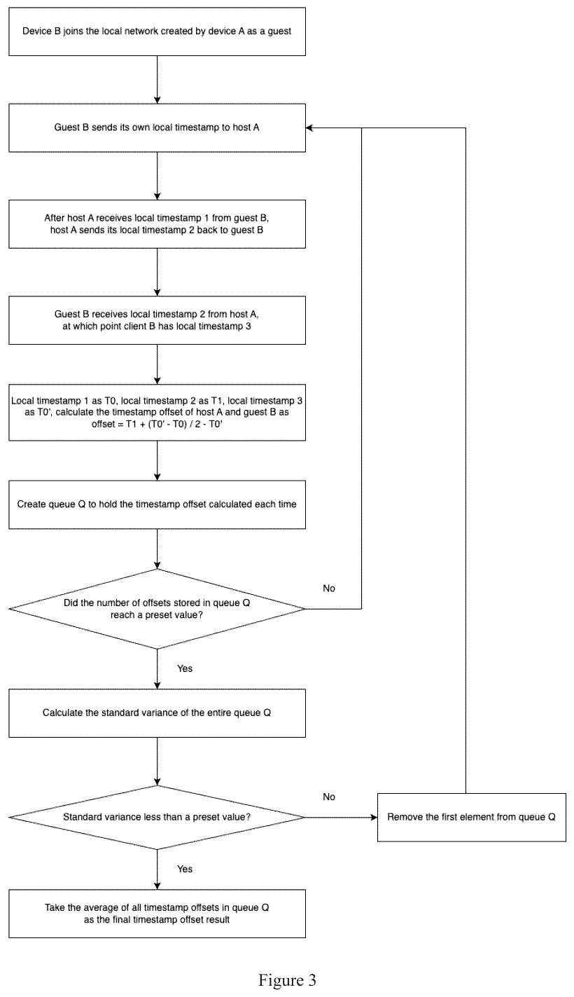

See FIG. 3 for a flow chart of time synchronization between local devices for this embodiment.

After a local network is established and all devices are added to the local network, the devices on the local network synchronize time, that is, calculate the local timestamp offset between two devices. Each device has its own local timestamp, which marks the time when any local operation occurred. In a device, time stamps can be implemented in many ways, such as counting the time, in seconds, between the time the device is turned on and the time the operation takes place. No matter what kind of timestamp implementation method is used, the timestamp remains correct and consistent on the local device, and the time stamp unit is the same between multiple devices, so the implementation of this technology has no impact. The purpose of calculating the timestamp offset between the two devices is to align the positions of the two devices at the same time with the rotation in the third part. All subsequent devices connected to the local network can repeat the same operation to synchronize the timestamp.

The specific process of time synchronization for devices on the local network is as follows: At A certain time, the local timestamp of guest B is T0. guest B sends the timestamp T0 to host A as a parameter and requests the timestamp of host A. When host A receives A timestamp request from guest B, its local timestamp is T1, and host A sends the received timestamp T0 and its own timestamp T1 back to guest B. When guest B receives the timestamp from the host, it has three timestamps locally on guest B: T0 when guest B sent the timestamp request to the host before, T1 when host A received the timestamp request, and T0′ when guest B received the timestamp from the host. The time offset between guest B and host A can be calculated by the following formula:

$$offset = T 1 + \frac{T {0}^{′} - T 0}{2} - T {0}^{′}$$

At this time, there is a time offset data in guest B, considering the impact of network delay, it is difficult to calculate the timestamp offset only once to get an accurate value. Therefore, in this embodiment, to ensure the accuracy and stability of the timestamp offset, the above steps are repeated, with each resulting timestamp offset stored in a queue Q created by guest B. When the number of timestamp offsets stored in queue Q reaches a preset number value, the standard variance of the whole queue is calculated. If the standard variance of the queue is too large (greater than the preset standard variance value), the earliest calculated timestamp offset data in the queue is abandoned (this is the queuing operation of the queue), and then continue to repeat the process of obtaining timestamps T0, T1, T0′ and calculating the time offset, obtaining a new time offset data and adding it to the queue. If the queue variance is less than the preset variance value, this means that the timestamp offset has stabilized at this time. The average of the entire queue Q can be calculated as the timestamp offset between the final guest B and host A.

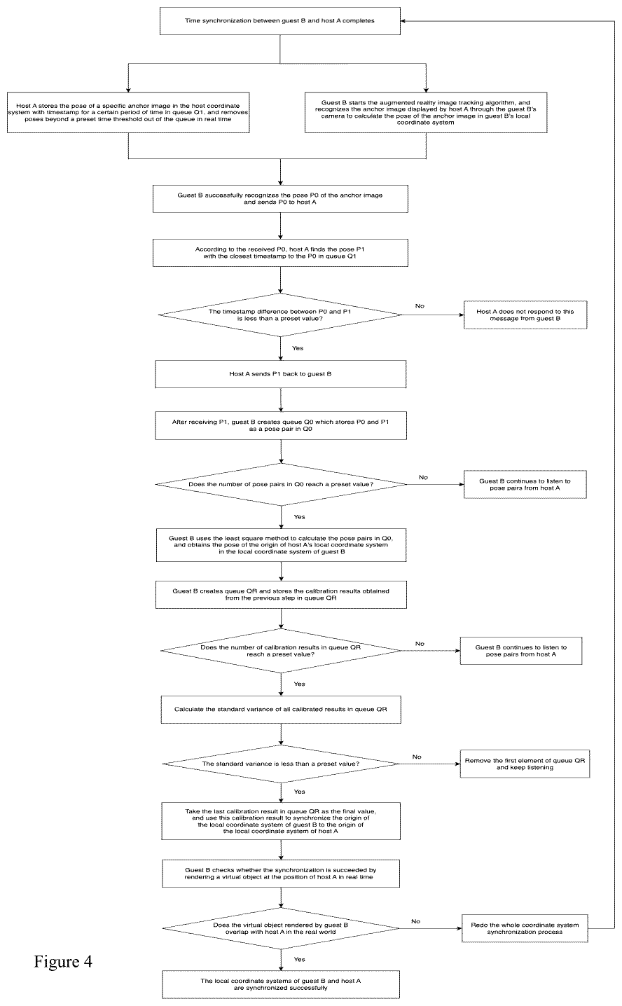

See FIG. 4 for a flow chart of spatial synchronization between local devices for this embodiment.

After the local network connection is established between guest B and host A and the local time stamp is synchronized, host A displays a specific picture on the display system as an anchor point, and starts to record the picture status pose (including position and rotation) within a period of time and attach a time stamp, and saves these time-stamped poses to queue Q1. Guest B uses augmented reality image tracking technology to scan and try to identify A specific image displayed on the display system of host A. Each time guest B finds the anchor point of the image of host A through the augmented reality image tracking algorithm, guest B immediately sends the time-stamped local position of this anchor point to host A.

A specific image as an anchor is displayed on the display system of host A. Host A itself is an augmented reality device. Through its accelerometer, gyroscope and imaging system, the position and rotation of the imaging system in the local coordinate system of host A can be calculated in real time. The difference between the center position of the image and the position of the imaging system is fixed. Therefore, host A can calculate the position and rotation of the image anchor point in real time. Guest B uses augmented reality image tracking technology to constantly look for A specific image displayed on the main screen in the images taken by its imaging system (this image is pre-set, so guest B knows what image is displayed on the main screen). This augmented reality image tracking technology can accurately identify the position and rotation of a specific image in the scene, so guest B can also know the position and rotation of the anchor point of the image.

The above augmented reality image Tracking technology for scanning specific images can use Apple's ARKit technology, or other imaging technology that supports the Marker Tracking method.

The above specific pictures are preset in advance for the program, it is best to use pictures that are complex enough and have enough feature points, and two-dimensional code pictures are a very good choice. In addition to the advantages of easy identification, the two-dimensional code picture itself has the characteristics of information that can send additional information from the host A to the guest B without going through the network. In addition to the two-dimensional code picture, any picture with enough feature points can also be used as a picture anchor.

At the same time that the guest B scans the specific picture displayed on the display system of the host computer A, the two devices are also sharing the spatial position, and the position and rotation of the two devices in the local coordinate system are transmitted to each other through the local network. Each time guest B successfully scanned A specific image displayed on host As display system as an anchor point, both devices knew the position and rotation of the anchor point in their respective local spatial coordinate systems. Through local network and time stamp synchronization, guest B can obtain the position and rotation of the anchor point in the space coordinate system of the two devices at the same time in multiple pairs. Through least square method, the position and rotation of the origin of the local space coordinate system of host plane A relative to the origin of the local space coordinate system of guest B are calculated. At this time, the origin of the local coordinate system of guest B is reset to the origin of host plane A. The origin and direction of the space coordinate system of the two devices are the same, so as to realize the synchronization of the space coordinate system of the two devices,

The objectives of the least squares method in this embodiment are as follows:

$$𝒜 = \{ {T}_{a , i} = [ \begin{matrix}{R}_{a , i} & {P}_{a , i} \\ 0 & 1\end{matrix} ] \vert i = 1 … , n \}$$

$$ℬ = \{ {T}_{b , i} = [ \begin{matrix}{R}_{b , i} & {P}_{b , i} \\ 0 & 1\end{matrix} ] \vert i = 1 … , n \}$$

R_(a,i) is the rotation of an anchor point under the space coordinate system of host A, P_(a,i) is the position of an anchor point under the space coordinate system of host A, R_(b,i) is the rotation of an anchor point under the space coordinate system of guest B, P_(b,i) is the position of an anchor point under the space coordinate system of guest B, A is the pose of A queue image anchor point in the local space coordinate system of host A, B is the pose of a queue image anchor point in the local space coordinate system of guest B. Queue A and queue B anchor point correspond to each other in the real world time.

Because two mixed reality devices can find the same Y-axis orientation based on gravity using the built-in gyroscope, a one-dimensional rotation along the Y-axis of the coordinate system needs to be found:

$${ℛ}_{y} ( ϕ ) : = [ \begin{matrix}cos ϕ & 0 & sin ϕ \\ 0 & 1 & 0 \\ - sin ϕ & 0 & cos ϕ\end{matrix} ]$$

And a three-dimensional vector t, transfers the origin of the coordinate system of guest B to the origin of the coordinate system of guest A. By solving a rotation Angle ϕ and vector t, the following formula is minimized (minimum error):

$$( ϕ , t ) = {arg min}_{ϕ ∈ ℝ , t ∈ {ℝ}^{3}} F ( ϕ , t )$$

F in the above formula can be expressed as:

$$F ( ϕ , t ) = {\sum }_{i = 1}^{n} {w}_{i} ( {‖ ( {ℛ}_{y} ( ϕ ) {P}_{a , i} + t ) - {P}_{b , i} ‖}^{2} - ctr ( {R}_{b , i}^{T} {ℛ}_{y} ( ϕ ) {R}_{a , i} ) )$$

Wherein, w represents the weight of each anchor pair, w_i>0; c represents the weight of the penalty, c>0; c is a constant. In this embodiment, position and rotation data with errors are processed simultaneously. By adjusting the value of c, the formula can be more biased towards smaller rotation errors or smaller displacement errors.

Next, calculate the optimal displacement vector assuming that Ry (d)) is fixed. You can find the optimal displacement vector by taking the derivative t, as follows:

$$0 = \frac{\partial F ( ϕ , t )}{\partial t} = 2 ( {\sum }_{i = 1}^{n} {w}_{i} ) t - 2 {ℛ}_{y} ( ϕ ) ( {\sum }_{i = 1}^{n} {w}_{i} {P}_{a , i} ) + 2 ( {\sum }_{i = 1}^{n} {w}_{i} {P}_{b , i} )$$

An expression for the optimal displacement vector t can be derived:

t=P̅_{b}− [symbol] _{y}(ϕ)Pₐ

Wherein P^{⊥-}a and P^{⊥-}b are respectively

$${\overline{P}}_{a} : = \frac{{\sum }_{i = 1}^{n} {w}_{i} {P}_{a , i}}{{\sum }_{i = 1}^{n} {w}_{i}}$$

$${\overline{P}}_{b} : = \frac{{\sum }_{i = 1}^{n} {w}_{i} {P}_{b , i}}{{\sum }_{i = 1}^{n} {w}_{i}}$$

Wherein, P^{⊥-}_a represents the weight central value of all anchor points in the host A coordinate system, and P^{⊥-}_b represents the weight central value of all anchor points in the B coordinate system of guest. Assuming that the rotation ϕ is constant, we can calculate the optimal displacement vector t by calculating the weight centers of A and B.

Finally, calculate the rotation:

P′_{a,i}:=P_{a,i}−P̅ₐ

P′_{b,i}:=P_{b,i}−P̅_{b}

P_(a,i)\hat{ }′ is the difference between an anchor point and its weight center in the space coordinate system of the host A, and P_(b,i)\hat{ }′ is the difference between an anchor point and its weight center in the space coordinate system of the guest B.

From the above formula that has been extrapolated to t with defined rotation ϕ, substituting the optimal displacement vector t into the target formula F yields:

$$\begin{matrix}ϕ = arg {min F}_{ϕ ∈ ℝ} ( ϕ , t ) = arg {min}_{ϕ ∈ ℝ} {\sum }_{i = 1}^{n} {w}_{i} ( {‖ {ℛ}_{y} ( ϕ ) {P}_{a , i}^{′} - {P}_{b , i}^{′} ‖}^{2} - c tr ( {R}_{b , i}^{T} {ℛ}_{y} ( ϕ ) {R}_{a , i} ) ) \\ = arg {min}_{ϕ ∈ ℝ} ( {\sum }_{i = 1}^{n} - 2 {w}_{i} {P}_{b , i}^{′ T} {ℛ}_{y} ( ϕ ) {P}_{a , i}^{′} - {w}_{i} c tr ( {ℛ}_{y} ( ϕ ) {R}_{b , i}^{T} {R}_{a , i} ) ) \\ = arg {max}_{ϕ ∈ ℝ} ( {\sum }_{i = 1}^{n} {w}_{i} {P}_{b , i}^{′ T} {ℛ}_{y} ( ϕ ) {P}_{a , i}^{′} + {w}_{i} {c}^{′} tr ( {ℛ}_{y} ( ϕ ) {R}_{i}^{′} ) )\end{matrix}$$

Because the matrix AB has the same trace as the matrix BA, i.e. tr(AB)=tr(BA), c\hat{ }′=c/2, target rotations can be computed with a pair of anchor rotations known as R_i\hat{ }′ R_(b,i)\hat{ }T R_(a,i), wherein R_i\hat{ }′ is the target rotation (the rotation difference between two coordinate systems), R_(b,i)\hat{ }T is the inverted matrix of the rotation matrix of the anchor in the guest coordinate system, R_(a,i) is the rotation of the anchor in the host coordinate system) and the best rotation is obtained by derivation ϕ:

$$0 = \frac{\partial }{\partial ϕ} ( {\sum }_{i = 1}^{n} {w}_{i} {P}_{b , i}^{′ T} {ℛ}_{y} ( ϕ ) {P}_{a , i}^{′} + {w}_{i} c tr ( {ℛ}_{y} ( ϕ ) {R}_{i}^{′} ) ) + {w}_{i} c tr ( [ \begin{matrix}cos ϕ & 0 & sin ϕ \\ 0 & 1 & 0 \\ - s in ϕ & 0 & ϕ cos\end{matrix} ] [ \begin{matrix}{R}_{i , {e}_{1} , x}^{′} & {R}_{i , {e}_{2} , x}^{′} & {R}_{i , {e}_{3} , x}^{′} \\ {R}_{i , {e}_{1} , y}^{′} & {R}_{i , {e}_{2} , y} & {R}_{i , {e}_{3} , y} \\ {R}_{i , {e}_{1} , z}^{′} & {R}_{i , {e}_{2} , z}^{′} & {R}_{i , {e}_{3} , z}^{′}\end{matrix} ] ) ) = \frac{\partial }{\partial ϕ} {\sum }_{i = 1}^{n} {w}_{i} ( ( {P}_{a , i , x}^{′} {P}_{b , i , x}^{′} + {P}_{a , i , z}^{′} {P}_{b , iz}^{′} + {cR}_{i , 1 , x}^{′} + {cR}_{i , 3 , z}^{′} ) cos ϕ ( {P}_{a , i , x}^{′} {P}_{b , i , z}^{′} - {P}_{a , i , z}^{′} {P}_{b , i , x}^{′} + {cR}_{i , 3 , x}^{′} - {cR}_{i , 1 , z}^{′} ) sin ϕ + {P}_{b , i , y}^{′} {P}_{a , i , y}^{′} + {cR}_{i , 2 , y}^{′} ) = - ( {\sum }_{i = 1}^{n} {w}_{i} ( {P}_{a , i , x}^{′} {P}_{b , i , x}^{′} + {P}_{a , i , z}^{′} {P}_{b , i , z}^{′} + {cR}_{i , 1 , x}^{′} + {cR}_{i , 3 , z}^{′} ) ) sin ϕ + ( {\sum }_{i = 1}^{n} {w}_{i} ( - {P}_{a , i , x}^{′} {P}_{b , i , z}^{′} + {P}_{a , i , z}^{′} {P}_{b , i , x}^{′} - {cR}_{i , 3 , x}^{′} + {cR}_{i , 1 , z}^{′} ) ) cos ϕ$$

The best rotation ϕ obtained from the above calculation is:

$$ϕ = arctan \frac{{\sum }_{i = 1}^{n} {w}_{i} ( - {P}_{a , i , x}^{′} {P}_{b , i , z}^{′} + {P}_{a , i , z}^{′} {P}_{b , i , x}^{′} - {cR}_{i , 3 , x}^{′} + {cR}_{i , 1 , z}^{′} )}{{\sum }_{i = 1}^{n} {w}_{i} ( {P}_{a , i , x}^{′} {P}_{b , i , x}^{′} + {P}_{a , i , z}^{′} {P}_{b , i , z}^{′} + {cR}_{i , 1 , x}^{′} + {cR}_{i , 3 , z}^{′} )}$$

Any number of subsequent devices added to the network can be synchronized with the spatial coordinates of host A through this method. After the synchronization is successful, A virtual object of the same size as the device of host A is rendered in the mixed reality virtual space of guest B, and the position and rotation of the virtual object are synchronized with that of host A in real time. If the spatial synchronization accuracy of the two devices is high enough, the virtual object and the real host A should coincide perfectly in the perspective of guest B; If the error between the two is too large, it means that the synchronization is unsuccessful, and guest B will repeat the space coordinate system synchronization process until it successfully achieves accurate space coordinate system synchronization with host A.

In another embodiment of the present application, a device subsequently added to the local network completes the synchronization of the spatial coordinate system by scanning a specific picture displayed on the guest display system that has synchronized the spatial coordinate system in the local network. Guest B connects to the local network created by host A and synchronizes the space coordinate system with host A by scanning the specific images displayed on the system by host A. After the new guest C joins the network, in addition to scanning the picture on the host A, guest C can also synchronize the space coordinate system with guest B by scanning the specific picture on the display system of guest B, because guest B has completed the space coordinate system synchronization with the host A, so at this time three devices A, B, C have successfully completed the space synchronization between each other. Similarly, when A new guest D is added, guest D can synchronize the spatial coordinate system with all devices in the network by scanning a specific image with any of the devices A, B, and C. Through the above method, the chain spatial coordinate synchronization is realized, so that any device in the local network can synchronize the spatial coordinate system with other devices nearby.

A local multi-device fast spatial anchor point synchronization system for mixed reality comprises a memory and a processor on which instructions are stored and the instructions enable the processor to execute: a local multi-device fast spatial anchor point synchronization method for mixed reality is described.

A machine-readable storage medium on which instructions are stored and used to cause the machine to execute: a local multi-device fast spatial anchor point synchronization method for mixed reality.

The above is only the preferred embodiment of the present application, and it should be noted that for ordinary technicians in the field, without deviating from the creation of the present application, several deformation and improvement can be made, which are within the scope of protection of the present application.

1. A local multi-device fast spatial anchor point synchronization method for mixed reality comprising following steps:
S1: establishing a local network connection for multiple devices locate(in the local space to achieve data transmission between devices, using any one of the multiple devices as a host to create a local network, other devices as guests to join the local network created by the host;
S2: synchronizing time between the host and the guest in the local network, wherein the guest and the host first exchange their respective local time stamps to each other, and then calculate the time offset between the local time stamp of the guest and the local time stamp of the host, according to the time offset to adjust and realize the time synchronization between the guest and the host;
S3: performing the spatial anchor point synchronization between the host in the local network and the guest, and using a specific picture displayed on the display system of the host as the anchor point, wherein the guest scans the specific picture through the augmented reality picture tracking technology to obtain the second position and rotation of the image anchor point in the space coordinate system of the guest; the first position and rotation of the anchor point in the host space coordinate system under the same time stamp is requested to the host, and the guest obtains two position and rotation data as a pose pair, the guest scans the anchor point several times to obtain multiple pose pairs, and calculates the multiple pose pairs by the least square method, the third position and rotation of the origin of the space coordinate of the host in the space coordinate system of the guest are obtained, by resetting the origin of the space coordinate system of the guest to the third position and rotation, to make the position and rotation of the origin of the space coordinate system of the host and the guest the same, and the synchronization of the space coordinate system between the devices is completed; other guests may synchronize spatial coordinate systems with hosts in the local network, or with guests that have completed spatial coordinate systems synchronization in the local network.

2. The local multi-device fast spatial anchor point synchronization method for mixed reality according to claim 1, wherein the step S1 is specifically:
S1-1: the host creates the local network and broadcasts on the local network through wireless communication;
S1-2: the guest searches the broadcast of the host through the wireless communication mode;
S1-3: the guest discovers the broadcast and sends a connection request to the host using the wireless communication mode; and
S1-4: the host receives the connection request, agrees to the connection request, and establishes a network connection between the guest and the host.

3. The local multi-device fast spatial anchor point synchronization method for mixed reality according to claim 1, wherein the step S2 is as follows:
S2-1: the guest sends the local time stamp of the guest to the host;
S2-2: the host sends the time point when the local timestamp one is received, to the guest as local timestamp two;
S2-3: the guest receives the time point of the local time stamp two as the local time stamp three, calculates and saves the timestamp offset between the guest and the host, according to the local time stamp one, local time stamp two and local time stamp three;
S2-4: repeat steps S2-1 to S2-3 until the number of timestamp offsets reaches the set value to obtain multiple timestamp offsets;
S2-5: calculate the standard variance of the multiple timestamp offsets, if the standard variance is not less than the preset value, then abandon the earliest calculated timestamp offset and repeat steps S2-1 to S2-3 until the standard variance is less than the preset value, calculate the average value of the multiple timestamp offsets as the final timestamp offset result; and
S2-6: other guests calculate the final timestamp offset result between each other guest and the host according to steps S2-1 to S2-5.

4. The local multi-device fast spatial anchor point synchronization method for mixed reality according to claim 3, wherein the formula for calculating the timestamp offset of step S2-3 is as follows:
$$offset = T 1 + \frac{T {0}^{′} - T 0}{2} - T {0}^{′}$$
wherein T0 is the local timestamp one, T0 is the local timestamp two, and T1 is the local timestamp three.

5. The local multi-device fast spatial anchor point synchronization method for mixed reality according to claim 3, wherein the guest creates a queue to save the multiple timestamp offsets.

6. The local multi-device fast spatial anchor point synchronization method for mixed reality according to claim 1, wherein the step S3 is specifically:
S3-1: a specific picture is displayed on the display system of the host, and the specific picture is an anchor point in space; the host uses an accelerometer, a gyroscope and an imaging system to calculate the position and rotation of the specific picture in the local coordinate system of the host in real time according to the invariant offset vector of the specific picture and the imaging system of the host;
S3-2: the guest in the local network uses the augmented reality picture tracking technology to scan the specific picture by the imaging system, the augmented reality picture tracking technology identifies the second position and rotation of the specific picture in the scene, sends the second position and rotation to the host, and receives the first position and rotation sent by the host; wherein the first position and rotation and the second position and rotation have the same timestamp;
S3-3: the guest obtains the first position and rotation, the second position and rotation under several pairs of different time stamps, and obtains the best displacement vector and the best rotation through least square calculation, and obtains the position and rotation of the local space coordinate system of the host relative to the origin of the local space coordinate system of the guest; the origin of the local space coordinate system of the guest is reset to the origin of the local space coordinate system of the host to complete the synchronization of the space coordinate system of the host and the guest; for other guests in the local network, the space coordinate system of the equipment in the local network is synchronized by resetting the origin of its own local space coordinate system to the origin of the local space coordinate system of the host or the origin of the local space coordinate system of any synchronized guest; and
S3-4: render a virtual object with the same size as the host in the mixed reality virtual space of the guest, and synchronize the position and rotation of the virtual object with the host in real time; if the virtual object does not fully coincide with the host in reality, the guest will repeat steps S3-1 to S3-3, until the virtual object is exactly coincident with the host in reality.

7. The local multi-device fast spatial anchor point synchronization method for mixed reality according to claim 6, wherein an expression of the optimal displacement vector t is:
t=P̅_{b}− [symbol] _{y}(ϕ)P̅ₐ
wherein, P^{⊥-}_a represents a weight center value of all anchor points in the host space coordinate system, P^{⊥-}_b represents a weight center value of all anchor points in the guest space coordinate system, and R_y(ϕ) is a rotation matrix with ϕ Angle rotating along the space Y-axis.

8. The local multi-device fast spatial anchor point synchronization method for mixed reality according to claim 6, wherein the calculation of the optimal rotational ϕ as:
$$ϕ = arctan \frac{{\sum }_{i = 1}^{n} {w}_{i} ( - {P}_{a , i , x}^{′} {P}_{b , i , z}^{′} + {P}_{a , i , z}^{′} {P}_{b , i , x}^{′} - {cR}_{i , 3 , x}^{′} + {cR}_{i , 1 , z}^{′} )}{{\sum }_{i = 1}^{n} {w}_{i} ( {P}_{a , i , x}^{′} {P}_{b , i , x}^{′} + {P}_{a , i , z}^{′} {P}_{b , i , z}^{′} + {cR}_{i , 1 , x}^{′} + {cR}_{i , 3 , z}^{′} )}$$
wherein, P_(a,i,x)\hat{ }′, P_(a,i,z)\hat{ }′ is a difference between an anchor point and its weight center under the host space coordinate system, P_(b,i,x)\hat{ }′, P_(b,i,z)\hat{ }′, is a difference between an anchor point and its weight center under the guest space coordinate system, R_(i,1,x)\hat{ }′, R_(i,1,z)\hat{ }′, R_(i,3,x)\hat{ }′, R_(i,3,z)\hat{ }′ is a rotation difference between the host and the space coordinate system of the guest, c is an adjustable constant greater than 0, by adjusting the value of c can make the formula more biased to a smaller rotation error or a smaller displacement error.

9. A local multi-device fast spatial anchor point synchronization system for mixed reality, wherein the system comprises a memory and a processor, instructions are stored on the processor and the instructions enable the processor to execute: according to any one of the local multi-device fast spatial anchor point synchronization method for mixed reality of claim 1.

10. A machine-readable storage medium, wherein instructions are stored on the machine-readable storage medium, and the instructions are used to cause the machine to execute: according to any one of the local multi-device fast spatial anchor point synchronization method for mixed reality of claim 1.
